(19) United States
(12) Patent Application Publication
(10) Pub. No.: US 2012/0138109 A1
(43) Pub. Date: Jun. 7, 2012

(54) Cleaning System For Collectors Combined With A Special Protective Position

(76) Inventor: Martin Hadlauer, Leoben (AT)

(21) Appl. No.: 13/377,552

(22) PCT Filed: Jun. 9, 2010
(86) PCT No.: PCT/EP2010/058114

§ 371 Date: Feb. 14, 2012

(30) Foreign Application Priority Data
Jun. 10, 2009 (AT) 8962009

(51) Int. Cl. B08B 3/02

(52) U.S. Cl. 134/172

(57) ABSTRACT

A cleaning system for solar collectors, characterized in that movably mounted cleaning nozzles for introducing steam or water are secured to collectors, which can be closed in pairs at the mirror ends. The cleaning process is to take place partially or completely in the closed state or protective position.

### FIELD OF INVENTION

The application relates to a cleaning system for collectors, in particular in combination with a special protective position. The application further relates to a retaining system for a solar collector system, in particular a moving apparatus with retaining and tracking functions.

### BACKGROUND OF INVENTION

Publication PCT/AT2004/000233 describes a novel collector system with mirror concentrating collectors, which are biaxially tracked. In addition to biaxial tracking, the ability to close the collectors in pairs at the mirror ends is demonstrated. This makes it possible to achieve an effective protection against damaging environmental influences on the one hand, and cuts the area exposed to wind in half in the protective mode on the other. The protective position is especially important to avoid damages given extreme environmental influences (sandstorms, hail, etc.), and to diminish the rate of contamination. All of the above notwithstanding, it is vital that the mirrors be routinely cleaned. The usual method of cleaning by spraying with water is very labor intensive, and requires a lot of water.

An object of a first aspect of the present invention, might be to include the compact protective position, with respective collectors closed in pairs at the mirror ends, into the automatic process of cleaning the collectors and thereby achieving an efficient cleaning with low water consumption. Surface damages caused by sand particles entrained in the jet of water can be largely prevented by a gentle cleaning routine.

Furthermore, a demand may arise for a retaining system for a solar collector system that is able to efficiently and effectively protect, support and/or carry solar collectors. In particular, supporting the solar collectors in an idle position may become possible.

### BRIEF SUMMARY OF INVENTION

This may be achieved according to the invention by introducing superheated steam or a steam/water mixture into the interior of the paired, closed collectors in the protective position, which softens up the dirt. In addition, the collectors may be uniformly heated with the steam. This may prevent thermal stresses on the sensitive glass mirrors. A rinsing step may subsequently be performed. To allow the water with the dirt particles to drain away, the collectors may be opened during flushing, or special openings may be provided via which the water or cleaning medium can drain. It is conceivable that the dirty water is collected via special receiving devices. Subsequently it can optionally be reused or used to irrigate agricultural lands.

The collectors or solar collectors may be fixed in position and additionally pressed against each other by a retaining bracket, thereby establishing a good seal. Basically any of the techniques used in a dishwashing machine can also be employed in this system. For example, there can be a prewash and main wash cycle, along with a concluding rinse cycle. The superheated steam and/or water may be introduced via a plurality of cleaning nozzles. The nozzles are ideally arranged movably. The nozzle configuration and progression of movement may be geared toward an optimal cleaning effect or are to be geared toward an optimal cleaning effect, wherein a wide variety of possible embodiments are conceivable. The cleaning nozzles are preferably retraced during collector operation, so as not to disrupt the optical path of the sunlight.

According to a portion of the first aspect of the invention a cleaning system for solar collectors is provided, which is characterized in that cleaning nozzles are attached to the collector for introducing steam or water. In other words, a cleaning system for solar collectors may be provided that has cleaning nozzles configured in such a way that a cleaning medium or cleaning fluid, in particular steam and/or water, is guidable to or introducible into a collector of the solar collector system.

According to another portion of the first aspect of the invention, a solar collector system may be provided, which comprises at least one collector and a cleaning system which is secured or attached to the collector and is configured in such a way that, by using the same, a cleaning medium or cleaning fluid, in particular steam and/or water, is guideable to or introducible into a collector of the solar collector system. The cleaning fluid may be water, steam or a water/steam mixture, and may also comprise cleaning agents, e.g., detergents or surfactants. In particular, the solar collector system may comprise a plurality, in particular an even number of solar collectors, and may be configured in such a way that the solar collectors are moveable from an open state into a closed state, or a protective position. In the protective position, respective two solar collectors may be supported by each other in such a way that the interior areas of the solar collectors are protected from environmental influences.

According to an exemplary embodiment of the first aspect, the cleaning nozzles may be movably mounted.

According to an exemplary embodiment of the first aspect, the cleaning nozzles may be arranged on a distributer ring, which can be extended via guides. In particular, the at least one solar collector may comprise a distributor ring on which the cleaning nozzles are arranged. The distributor ring may optionally be configured so that it is movable by way of guides.

According to an exemplary embodiment of the first aspect, the collectors may assume a closed protective position with the interior space sealed during the cleaning process. In particular, the solar collector system may optionally be configured in such a way that the collectors assume a closed protective position during the cleaning process, in which an interior space between the collectors is sealed. In particular, the interior space may be formed between paired solar collectors of the solar collector system.

According to an exemplary embodiment of the first aspect, the protective position may be achieved by closing the collectors in pairs at the mirror ends. In particular, the solar collector system may comprise a plurality of solar collectors, and may be configured in such a way that the protective position is achievable by closing the solar collectors in pairs at mirror ends of the solar collectors.

According to an exemplary embodiment of the first aspect, rubber sealings may be secured to the mirror ends. In particular, the solar collector system may comprise rubber sealings arranged at the mirror ends of the solar collectors.

According to an exemplary embodiment of the first aspect, the collectors may be stably positioned in the protective position and pressed against each other by a retaining device. In particular, the solar collector system may comprise a retaining device configured in such a way that the solar collectors are stably positioned in the protective position and pressed against each other via the retaining device.

According to a portion of a second exemplary aspect a retaining system for a solar collector system is provided, wherein the retaining system comprises two swiveling arms, which can assume a working position and an idle position, and are configured so that solar collectors are couplable thereto, further a retaining device, which is couplable to a base or foundation of a solar collector system, and at least one receptacle element, which is couplable to at least one of the swiveling arms, wherein the retaining device and receptacle element is couplable in such a way as to absorb forces of the swiveling arms and solar collectors when in the idle position.

In particular, the retaining device may optionally be directly coupled or couplable to a base of the solar collector system in such a way that, by way of the retaining device, a load relieving of a base rod assembly, to which the swiveling arms are attached, is enabled. For example, the retaining device may optionally introduce the forces directly or by way of only a base or floor plate into a foundation or the floor. Expressed differently, a retaining device of the kind mentioned above may be distinguished from just a mere brace, which while it can be coupled with one end to a point on a swiveling device, is coupled at its other end to a pedestal or rack of a solar collector system to which the retaining system belongs. As a consequence, such a brace does not provide any additional point at which force or moments can be introduced into the foundation or a floor plate. Conversely, a retaining device of the kind mentioned above can be used to support the swiveling arms at multiple points on the foundation, base or base plate.

In particular, the term forces may also encompass moments. Examples for such forces may include especially torques, gravitational forces along with static or dynamic forces. As an example, the swiveling arms may be configured to be pivotable or swivelable. In particular, the idle position of the swiveling arms or solar collectors may correspond to a position in which the solar collectors come into contact with each other. For example, the solar collectors in the idle position may comprise a closed arrangement or alignment, in which energy-absorbing or active surfaces, e.g., the light-sensitive side of solar cells, are facing each other, and the solar collectors optionally come into contact with each other on a frame of the solar cells, so that a closed arrangement may be achieved which may provide protection to the energy-absorbing surfaces.

According to a portion of the second exemplary aspect a retaining system for a solar collector system is provided, wherein the tracking system comprises a retaining system according to an exemplary aspect and a swiveling device, wherein the swiveling arms are mounted to the swiveling device, and wherein the swiveling device is configured to pivot the swiveling arms between the working position and the idle position. In particular, the swiveling device or rotational device may optionally comprise a gear unit or may be part of a gear unit.

According to a portion of the second exemplary aspect a solar collector system is provided that comprises a tracking system according to an exemplary aspect, a plurality of solar collectors, wherein each of the solar collectors is mounted to one of the two swiveling arms, and further a base rod assembly, which is attachable to a foundation, and to which the tracking system is coupled or mounted. In particular, the solar collector system may optionally comprise a suspension mount immovably secured to the foundation, on which a gear unit can be mounted on flanges with purposefully positioned screw connections at the proper inclination relative to the horizontal.

For example, the term solar collector may be understood in particular as the entirety of elements in an arrangement that are required to convert the radiant energy from the sun or light into another form of energy, e.g., heat or electrical current. As a consequence, in particular in a thermal solar collector, i.e., a solar collector that converts radiant energy from the sun into heat, the absorber may be part of the solar collector, since it is precisely what performs the energy conversion. While any mirrors or beam deflecting or beam bundling elements that might be present may also be part of the solar collector, they cannot in and of themselves be construed as the solar collector without an absorber. In particular, the retaining system may make it possible to move two solar collectors relative to each other, wherein one of the solar collectors is secured to the one swiveling arm, and the other solar collector to the other swiveling arm.

By providing a retaining system and the proper receptacle elements on the swiveling arms it may be possible to support the swiveling arms in an idle position, or to deflect forces from the latter. Thus it may be possible to achieve an effective and efficient relief for the swiveling arms and, if provided, a gear apparatus coupled thereto. In particular given strong winds, for example, the idle position can here be used and serve to protect the solar collectors on the one hand, and reliably absorb the higher load encountered during these winds on the other.

Other configurations of the retaining system for the second aspect are described below. However, the configurations also apply with respect to the tracking system and solar collector system.

According to an exemplary embodiment of the retaining system of the second aspect, the two swiveling arms are configured in such a way that they are pivotable around a common axis. In particular, the common axis may be realized by a common swiveling device or common rotational unit. For example, both swiveling arms may be mounted to the same swiveling device, which comprises a rotational axis.

According to an exemplary embodiment of the retaining system of the second aspect, the retaining device is movable. In particular, the retaining device may be moveable or pivotable between an idle position and an active position. For example, the receptacle elements may not engage with the swiveling arms with the retaining device in the idle position, while the retainers on the swiveling arms may be engaged with the retaining device in the active position. Thus, the idle position of the retaining device may correspond to a working position of the swiveling arms or solar collectors coupled thereto, while the active position of the retaining device corresponds to the idle position of the swiveling arms or solar collectors coupled thereto. In this conjunction, “correspond” may in particular denote a chronological simultaneity.

According to an exemplary embodiment of the retaining system of the second aspect, the retaining device is formed pivotable, wherein a swiveling axis of the retaining device is defined by a bearing supported axis. In particular, the axis may be coupled or bearing supported on a base of the solar collector system. For example, the base may be formed by a foundation and bearing blocks secured thereto.

According to an exemplary embodiment of the retaining system of the second aspect, the retaining device comprises at least one insertion head, which, in the idle position of the swiveling arms, engages into the receptacle element of a swiveling arm. In particular, each of the swiveling arms may comprise its own receptacle element, and the retaining device may comprise a corresponding number of insertion heads, wherein one insertion head preferably engages into one respective receptacle element.

Other configurations of the tracking system of the second aspect are described below. However, the configurations also apply with respect to the retaining system and solar collector system.

According to an exemplary embodiment of the tracking system of the second aspect, at least one of the swiveling arms is integrally formed with a portion of the swiveling device. In particular, such an integrally configuration of a swiveling arm on a swiveling device or at least portions of this swiveling device may be construed as an “attachment” to the latter. Descriptively the driven swiveling arm and the swiveling device may be fabricated as a part that assumes a retaining and swiveling function. The part of the swiveling device with which the swiveling arm may be integrally formed or formed as one piece may in particular be a part that directly connects or couples the swiveling arm with the central axis.

According to an exemplary embodiment of the tracking system of the second aspect, the swiveling arms are mounted to the swiveling device by flange joints. In particular, the swiveling arms may be mounted to the flange joints of the swiveling device by a screwed connection or other suitable joining or attachment methods.

According to an exemplary embodiment of the tracking system of the second aspect, the flange joints are pivotably bearing supported (gelagert). In particular, the flange joints may pivot 180°. For example, they may be moved between a first stop point and second stop point. The first stop point may be defined by a point where the solar collectors come into contact with each other, wherein a first is coupled to one of the two swiveling arms, and a second is coupled to the second swiveling arm, for example. This contact position may be assumed in particular when the swiveling arms are in the idle position, and may represent a closed position, for example, in which the solar collectors or at least segments or parts of the solar collectors are protected against outside influences. The second stop point may be defined by a point where special stop buffers are provided. Preferably the flange joints are pivotable independently of each other, i.e., the two flange joints can be turned at different angles with respect to each other.

According to an exemplary embodiment of the tracking system of the second aspect, the tracking system comprises a gear unit, and is formed as a biaxial tracking system, wherein the gear unit comprises two additional rotational axes. In particular, these two additional rotational axes may form tracking axes, i.e., be suitable for tracking solar collectors mounted to the tracking system depending on the position of the sun. The two additional rotational axes (tracking axes) may in particular be distinguished from the rotational axis used to swivel the swiveling arms from the working position to the idle position, one of the additional rotational axes however may coincide with this rotational axis, or at least may have the same direction.

According to an exemplary embodiment of the tracking system of the second aspect, the two additional rotational axes are arranged at an angle relative to each other, and configured in such a way that, by means of these additional rotational axes, the solar collectors are moveable from a first working position into a second working position. In other words, the two additional rotational axes (tracking axes) are not aligned parallel to each other, and a biaxial tracking system may be formed. In particular, the gear unit may comprise a gear head, and switching from a first to a second working position may serve to bring the swiveling device of the gear unit, e.g., the gear head, into a corresponding position, so that the solar collectors are tracked, i.e., their alignment is adjusted to the position of the sun.

According to an exemplary embodiment of the tracking system of the second aspect, the angle between the two additional rotational axes measures 90°. Expressed differently, the tracking axes are arranged at an angle of 90° relative to each other. The primary rotation of the day may take place around a primary axis, an axis aligned essentially parallel to the earth's axis, with a turning or adjusting capacity of up to 360°. The second tracking axis oriented normally or perpendicularly thereto, the ecliptic axis, may serve mainly to bring the solar collectors into the ideal tracking position corresponding to the seasonal ecliptic position. It is here enough to enable a pivoting motion of at most +−25°.

The rotational axis of the rotatable flange joints on the gear head or on the swiveling device may differ by 90° from one of the primary rotational axes of the gear unit, in particular from the ecliptic axis, i.e., may essentially be perpendicularly on this axis.

According to an exemplary embodiment of the tracking system of the second aspect, the gear unit comprises a gear head, which can be tracked by the two additional rotational axes, wherein one rotational axis of the rotatable flange joints is fixedly anchored on the gear head, and aligned normally, i.e., perpendicularly, to one of the additional rotational axes. In particular, the additional rotational axis with respect to which the rotational axis of the rotatable flange joint is normally aligned may be the ecliptic axis.

According to an exemplary embodiment of the tracking system of the second aspect, the gear unit comprises a main drive, which is configured in such a way that, by using the same, the gear head or the swiveling arms are rotatable or pivotable around a first of the two rotational axes, in particular the primary axis, of the rotational device.

According to an exemplary embodiment of the tracking system of the second aspect, the gear unit comprises a spindle drive, which is configured in such a way that, by using the same, the gear head or the swiveling arms are rotatable or pivotable around a second of the two rotational axes, in particular the ecliptic axis, of the rotational device.

Viewed in general terms, according to an exemplary embodiment of the tracking system a solar collector system may be provided that comprises swiveling arms and a supporting or retaining device, wherein the swiveling arms are bearing supported to be pivotable with respect to each other around a common axis, and wherein the retaining device is moveable in such a way as to be brought into a retaining position to support the swiveling arms with the collector in the closed position. Thus, a solar collector system may be provided in which the tracking outlay is lessened, and a compact protective position with the collectors respectively sealed in pairs at the mirror ends is achievable. According to this exemplary aspect, the mirror ends, in the closed state, may lie in a vertical semi-plane under the swiveling axis. One swiveling arm (guiding arm) is coupled with a drive, while the other swiveling arm (hauling arm) is bearing supported so that it can freely rotate around a shaft rigidly fixed to the guiding arm. The latter can be rotated by precisely 180°, controlled by a stop. The mirror ends may act as the stop in the closed state, while the swiveling arms may rest on specially provided stop devices in the open state. It is preferred that no drive mechanism is provided for closing and opening purposes. An arresting device may be provided to prevent the collectors from inadvertently collapsing from an open state due to wind forces or an unfavorably positioned center of gravity. The latter may be activated with an actuator (e.g., magnet). Preferably also the arresting device functions purely by gravity, so that a power failure will not lead to a safety risk. The retaining device is preferably designed as a swiveling mechanism, which rotates via an axis stably bearing supported on the foundation. The retaining device may be furcated, with two plate-like insertion heads at the ends. If the collectors are closed, the insertion heads may enter into special receptacles on the swiveling arms. Special arresting mechanisms may optionally also be provided. A wide variety of actuators, electrically operated spindle drives, hydraulic or pneumatically operated lifting devices, chain drives, etc., may be used for moving the retaining fork. The retaining fork holds the collectors laterally and toward the connecting line of the fork supporting and insertion head. The lateral holding keeps twisting or torsional forces caused by wind loads away from the tracking gearbox.

In summation, it must be noted that, while the cleaning system or the solar collector system with a cleaning system and the retaining system or tracking system for a solar collector system have been described as two different aspects, they can of course also be combined by the expert. For example, a cleaning system described as an exemplary embodiment in conjunction with the first aspect can of course also be realized in a solar collector or solar collector system according to the second aspect. Conversely, a solar collector system according to the first aspect can of course comprise a retaining system or tracking system according to any of the exemplary embodiments of the second aspect.

### BRIEF DESCRIPTION OF THE FIGURES

Additional features and details concerning the two aspects of the invention may be gleaned from the following description of the figures, wherein FIGS. 1 to 8 relate to the second aspect, and FIGS. 9 to 12 relate to the first aspect. Shown on:

FIG. 1 is a diagrammatic view of the known sequence of movement via two swiveling axes aligned parallel to each other.

FIG. 2 are four different views of a solar collector system according to a first exemplary embodiment, wherein the solar collector system comprises four solar collectors on two swiveling arms.

FIG. 3 are two different views of a solar collector system according to a second exemplary embodiment, wherein the solar collector system comprises ten solar collectors on two swiveling arms.

FIG. 4 are two views of a gear unit, once in the open state (top), and once in the closed state.

FIG. 5 is a detailed view of the gear head or the swiveling device for the swiveling arms as part of the gear unit.

FIG. 6 is a top view and bottom view of an exemplary embodiment for a collector arm with an integrally configuration of the swiveling device and swiveling arms.

FIG. 7 is a detailed view of the bottom view from FIG. 6.

FIG. 8 is a detailed view of the integrally configuration of the swiveling device on FIG. 6.

FIG. 9 is a diagrammatic view of a mirror collector system in an open state and in a protective position.

FIG. 10 is a view of two collectors closed in pairs.

FIG. 11 is a cleaning cycle with nozzles retracted and extended, and the cleaning process.

FIG. 12 is a possible mechanism for extending the nozzles.

### DETAILED DESCRIPTION OF THE FIGURES

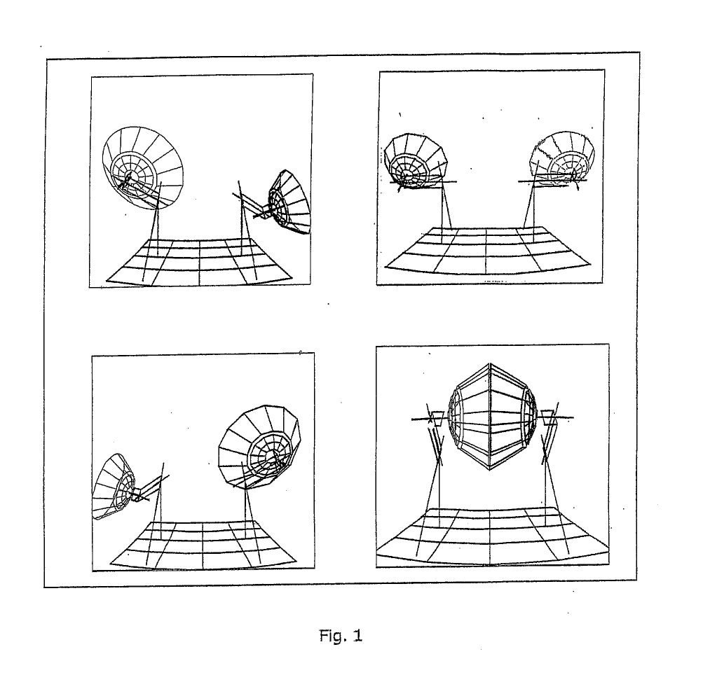

The second aspect, i.e., a retaining system for a solar collector system, in particular a moving apparatus with retaining and tracking functions, will be described in greater detail below with reference to FIGS. 1 to 8.

FIG. 1 shows a diagrammatic view of the known sequence of movement via two swiveling axes aligned parallel to each other, for example of the kind known from WO2005/003644. In the closed state, the collectors are turned upward, and mutually support each other at the mirror ends. The separate tracking, high loads on the retaining arms and upwardly set idle position result in a complicated structural implementation.

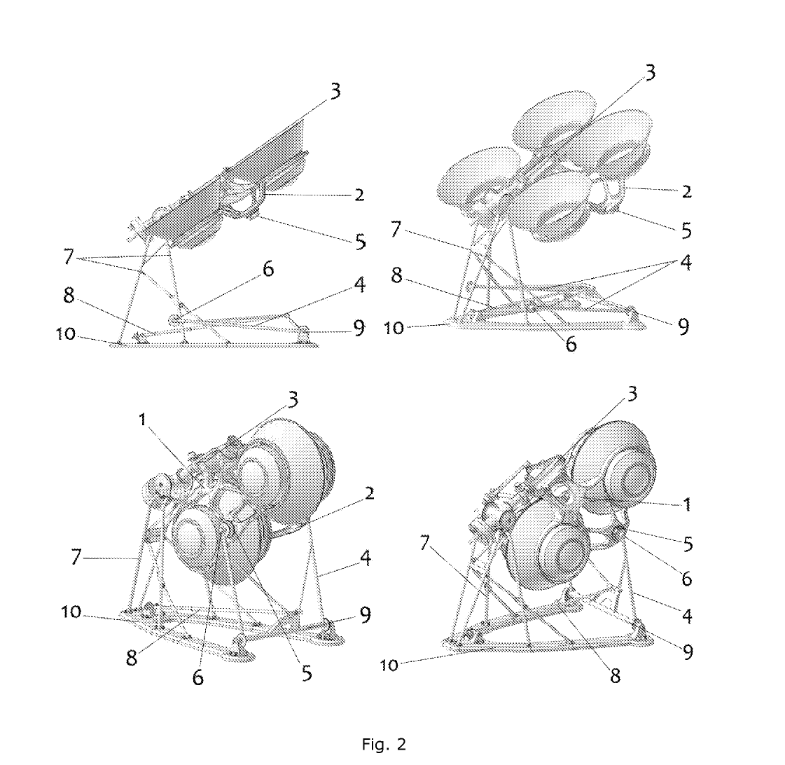

FIG. 2 shows four different views of a solar collector system according to a first exemplary embodiment, wherein the solar collector system comprises four solar collectors on two swiveling arms 1, 2, wherein the swiveling arms 1, 2 are arranged around a common central axis 3, around which they are moveable in an open or closed state. The two top images show the solar collector system in an open state or working position, wherein the two views are shown from two different perspectives for purposes of clarifying the structural design. The two bottom images show the solar collector system in a closed state or idle position, i.e., in a state where a respective two solar collectors come to rest against each other. One important aspect shown on FIG. 2 involves the arrangement of the two swiveling arms 1, 2 around the central axis 3. Further, the solar collector system comprises a retaining device 4 with two insertion heads 6, which can be introduced into receptacles 5 formed on the swiveling arms with the solar collectors in the closed state. The holding provided by a rack 7 and two holdings on the insertion heads 6 of the retaining device 4 yields a stable three-point base via a foundation 10 of the solar collector system. When the insertion heads 6 engage, the solar collectors can be pressed against each other, thereby enabling an improved seal, and can be optimally retained against laterally arising wind forces. The retaining device 4 is driven around a rotational axis 9 on the foundation 10 by an electrically operated spindle drive 8.

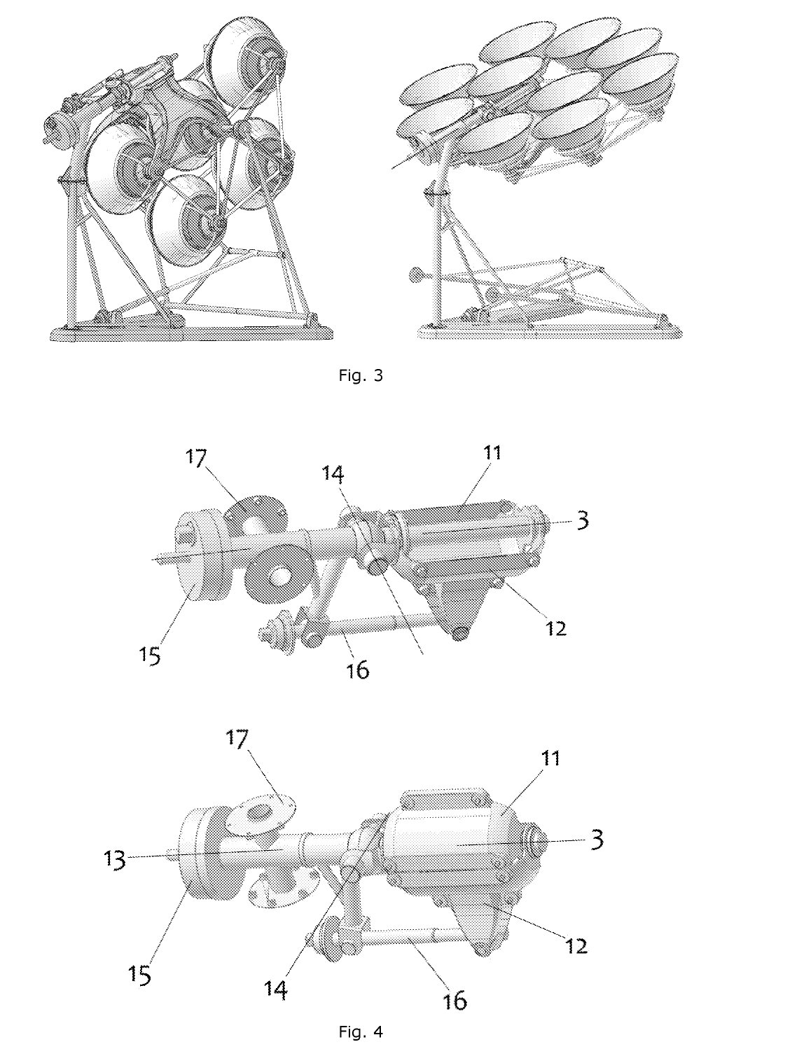

FIG. 3 shows two views of a solar collector system according to a second aspect in the open and closed state. The solar collector system of FIG. 3 differs from the one depicted of FIG. 2 in that it comprises ten solar collectors, which are secured to two swiveling arms 1, 2. However, it must be noted that a solar collector system can comprise any suitable number of solar collectors. In particular, a solar collector system may comprise any even number of solar collectors, so that pairs of solar collectors can be formed, which contact or support each other in an idle position. Aside from the dimensions and specific configurations of the individual assemblies, which are adjusted to the altered number of solar collectors, the functional principle of the solar collector system of FIG. 3 is identical to the one for the solar collector system of FIG. 2. Since the individual components or assemblies depicted in FIG. 3 assume the same functions as the ones shown in FIG. 2, the functional principle will not be described in any greater detail, and the reference numbers on FIG. 3 will be omitted for reasons of improved clarity. Even clearer than in FIG. 2 FIG. 3 illustrates that the weight-induced torque on the main rotational axis 13 becomes relatively small with the solar collectors open, since its center of gravity comes to lie close to the rotational axis.

FIG. 4 shows two views of a gear unit, once in the open state (top), and another in the closed state (bottom), i.e., in the working state and idle state, respectively, for the quadruple rack as depicted on FIG. 2 as a complete module. Such a gear unit or such a module can be furnished completely preassembled as an assembling unit, and subsequently built into a solar collector system during its installation. The gear unit satisfies the functions involved in biaxially tracking the solar collectors by way of axes 13 and 14, as well as the function of pivoting the swiveling or retaining arms to open and close the solar collectors by way of axis 3, which is bearing supported so that it is pivotable around axis 14. If necessary, desired electrical and hydraulic lines can already be integrated into the gear unit, along with desired drives. For example, a main gearing 15 for rotation around axis 13 and/or a spindle drive 16 for rotation around axis 14 may already be provided in the prefabricated module, so that a later installation of the solar collector system may be simplified. The gear unit can be rigidly mounted to the rack 7 during assembly or installation in the field. The setting of the main axis 13, i.e., the angular setting of the main axis 13 relative to a foundation of the solar collector system, may already be precisely prescribed by correctly placing boreholes on the main flanges 17. The main flanges 17 are mounted on counter-flanges of the rack 7 fixedly anchored with respect to the foundation. The rack 7 may be designed as a framework structure according to the images on FIG. 2 and FIG. 3, as a massive cantilever structure, or as an open shell structure. The gear head is provided with two rotating flanges 11, 12, to which the two swiveling arms with the collector receptacles and retaining receptacles 5 are screwed.

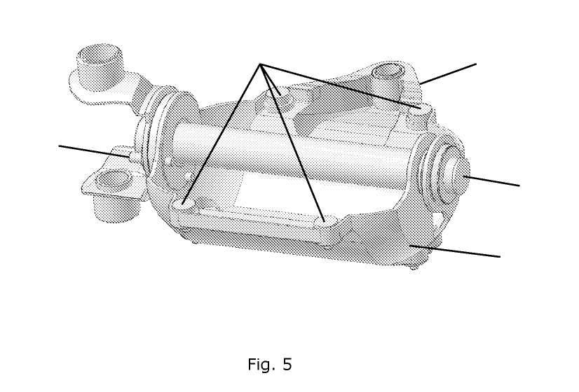

FIG. 5 shows a detailed view of the gear head or the swiveling device for the swiveling arms as part of the gear unit from FIG. 4. The rotating flanges 11, 12 are, by way of the rotating axis 3, rotatably bearing supported (gelagert). The gear head comprises two stop buffers 18, which allow the swiveling arms 1, 2 to rotate 180° out of the closed state or idle position of the swiveling arms, so that all solar collector pairs point in the same direction in the open state. An arresting device 19 may be used to rigidly couple together the rotating or retaining flanges 11, 12, so that the swiveling arms, and hence the solar collectors attached thereto, can be prevented from inadvertently collapsing.

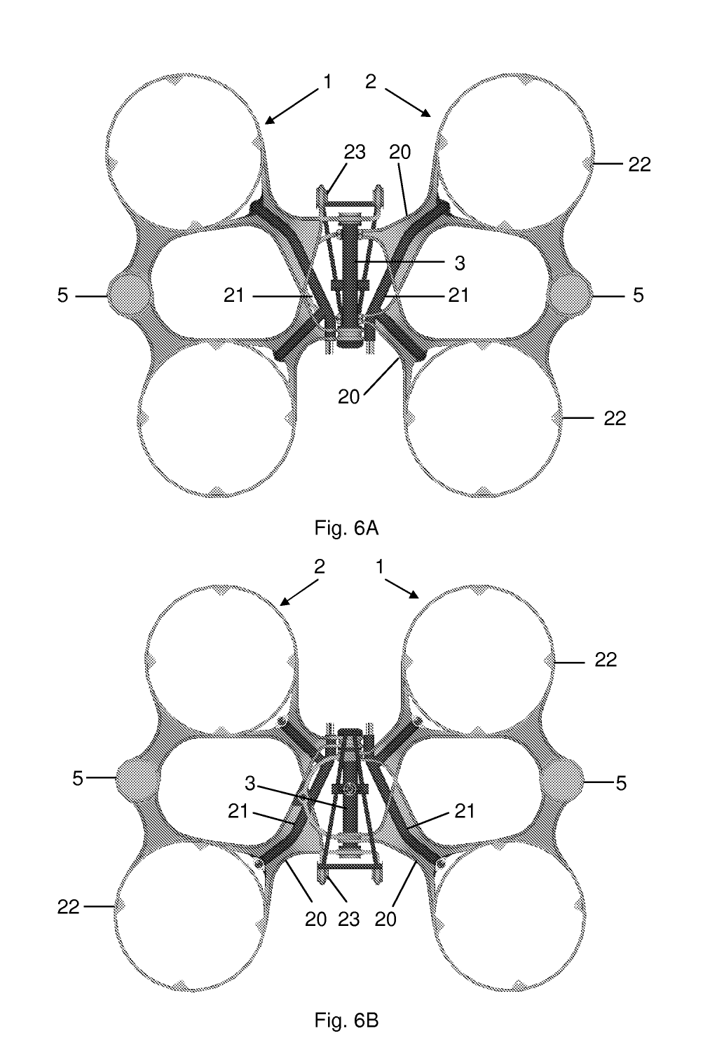

FIG. 6 shows a top view and a bottom view of an exemplary embodiment for a collector arm with an integrally configuration of the swiveling device and swiveling arms. In particular, FIG. 6A shows a top view of two swiveling arms 1 and 2, which are directly mounted rotatably or pivotably to a central axis 3. In this conjunction, directly means that the swiveling arms and swiveling device are fabricated as a single piece, i.e., no flanges are required, as for example those depicted for the gear unit on FIGS. 4 and 5 and labeled 11 and 12. The swiveling arms may here have a flat configuration, and comprise stiffeners 20 and support arms 21, which may be designed to transmit forces or moments. Furthermore, FIG. 6 also provides a diagrammatic view of areas 22 in which solar collectors can be formed. Additionally shown are lugs 23, which are designed to hold the ecliptic axis or shaft labeled 14 in FIG. 4.

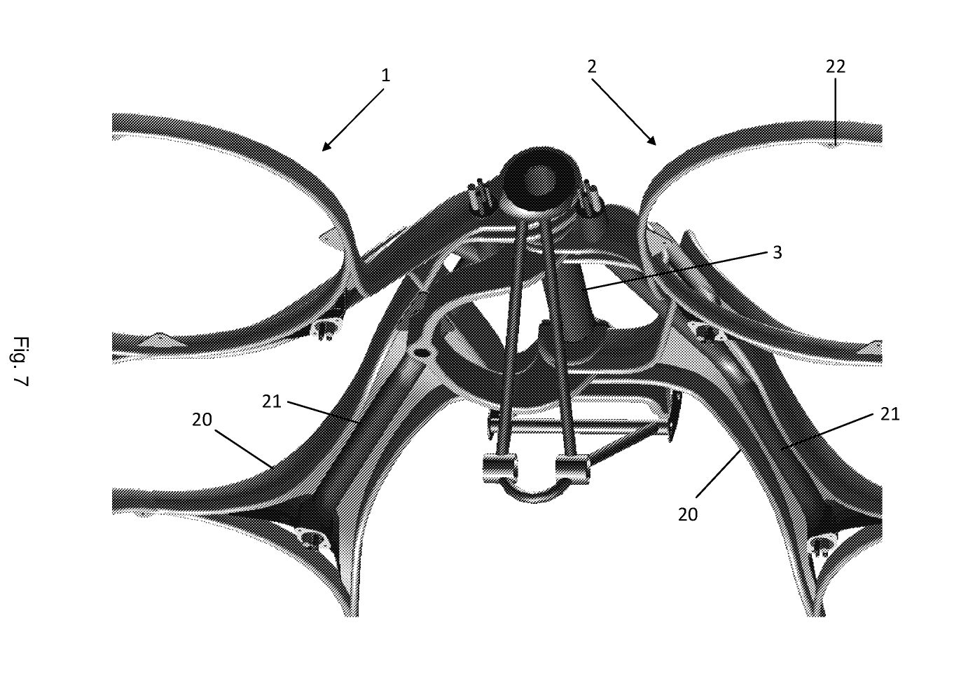

FIG. 7 is a detailed view of the bottom view from FIG. 6, in which the essential elements or components of the swiveling arms 1 and 2 are evident. As may be gleaned once again here as well, the latter are integrally designed with the swiveling device, i.e., no flanges are required to mount the swiveling arms to the swiveling device.

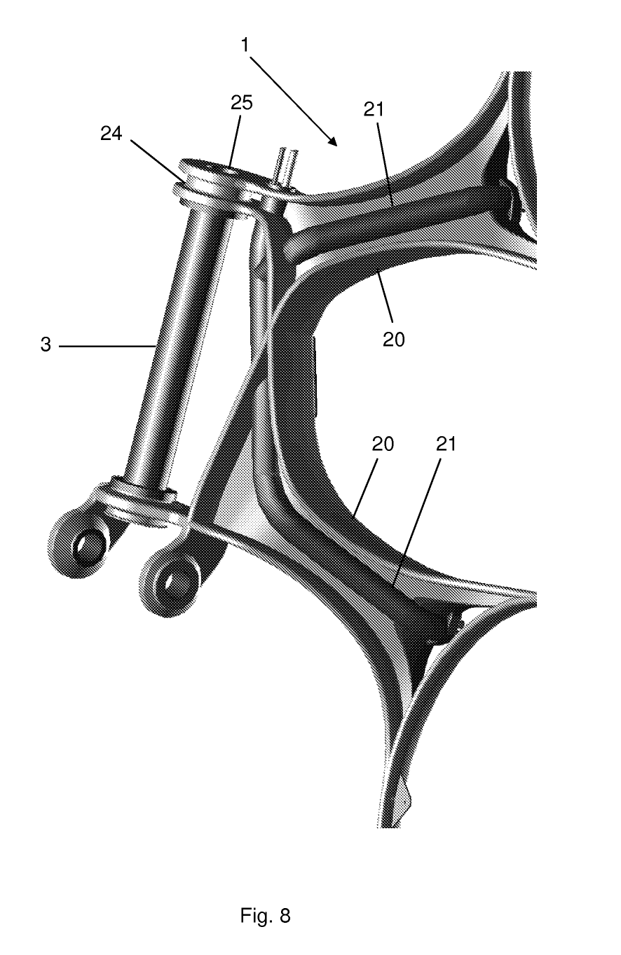

FIG. 8 is a detailed view of the integrally configuration of the swiveling device of FIG. 6, wherein just a single swiveling arm 1 is now depicted for purposes of improved clarity. The second swiveling arm 2 can essentially mirror the depicted swiveling arm 1, and can be bearing supported together with the latter so that it is pivotable around a central axis 3. To this end, the swiveling arm 1 comprises guide grooves 24, into which the second swiveling arm can engage, so that it is bearing supported in such a way that it is pivotable around the central axis 3 independently of the first swiveling arm 1. As an alternative, it may also comprise additional lugs. The latter may be arranged parallel to the opening 25 shown in FIG. 8, through which a central axis or shaft can then be guided, which then makes it possible to move the solar collectors from the idle position into the working position. Furthermore, as already explained in conjunction with FIG. 6, the lugs 23 are used to bearing support the swiveling arm so that it is pivotable around an ecliptic axis.

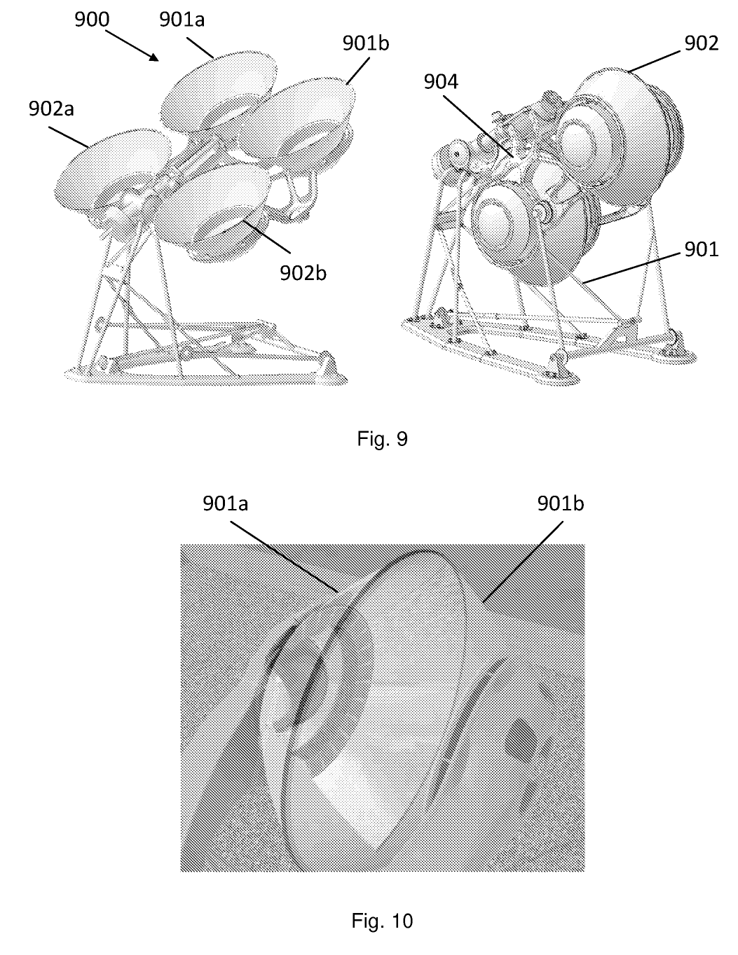

The first aspect, i.e., a cleaning system for a solar collector system, or a solar collector system with a cleaning system will be described in greater detail below with reference to FIGS. 9 to 12.

FIG. 9 shows a diagrammatic view of a mirror collector system 900 in an open state and in a protective position. By a retaining device 901 the collectors are stably fixed in place and pressed against each other. This establishes a good seal at the mirror ends, where rubber sealings 902 are ideally secured.

In particular, FIG. 9 shows a mirror collector system 900 with two pairs of individual collectors 901a, 901b, 902a and 902b, which are movably bearing supported on a frame 903. To this end, the mirror collector system comprises two swiveling arms 904, wherein a first collector of each collector pair is attached to a first swiveling arm, while the second collector of each collector pair is secured to the second swiveling arm. The swiveling arms are pivotable around a common axis or shaft in such a way that the collectors are moveable or switchable from the open state to the protective position. The rubber sealings 902 are preferably arranged at the mirror end of at least one individual collector of each collector pair, and may serve for effectively sealing the collector pair in the closed state or protective position of the mirror collector system.

FIG. 10 shows a view of two collectors 901a and 901b closed in pairs, with a cross fade into the interior space, i.e., the interior space formed by each pair of collectors in the protective position, as also illustrated in FIG. 10, thereby making an interior region of the individual collector visible in spite of the closed state. The interior space is sealed to the outside. This is the ideal position for the entire cleaning process or for a special program section of the cleaning process.

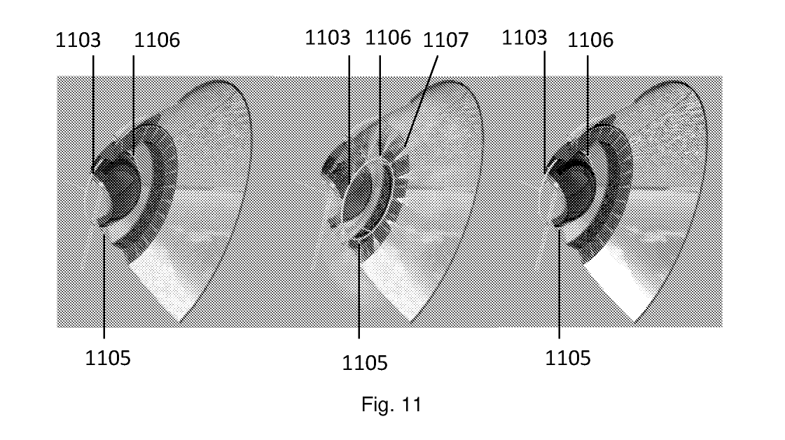

FIG. 11 shows a cleaning cycle with nozzles retracted and extended, and the cleaning process. For illustrative purposes, the process is depicted for an open collector. An annular nozzle arrangement is extended into a favorable position for cleaning purposes. The nozzles can already be opened during the extending process. Ideally, the system functions purely in response to system pressure. Control valves are used to automatically control the cleaning process. Devices for generating hot water and/or steam can be supplied with solar energy.

In particular, FIG. 11 depicts parts of a cleaning cycle. The annular nozzle arrangement 1105, for example which may be designed as a conducting or distributing loop 1103 with nozzles 1106 located thereupon, is in a retracted state in FIG. 11A, in which they pose or cause the least possible limitation on power and/or heat generation. As a consequence, the retracted state essentially corresponds to the operating state, i.e., energy conversion, of the collector system. FIG. 11B shows the collector from FIG. 11A during a cleaning process, which is diagrammatically depicted by atomized spray 1107 that exits the nozzles. During the cleaning process, the annular nozzle arrangement 1105 is in a position favorable for cleaning purposes, i.e., the ring may be moved or extended relative to the position in FIG. 11A, so that the mirror of the collector can be efficiently cleaned. On FIG. 11C, the nozzle arrangement is again shown in its idle state or retracted state. The nozzle arrangement may preferably switched from its idle state to the cleaning state or vice versa solely in response to the system pressure, i.e., the pressure of the cleaning medium, which is guided to the conducting loop 1103 and the nozzles 1106. As an alternative, additional actuators may also be used, which move or at least help to move the nozzle arrangement. The solar collector system may comprise a control unit, which controls or regulates the sequence of the cleaning process. In particular, this control unit may control the control valves and/or the retraction or extension of the nozzle arrangement. The control unit may include an automatic controller, or may take into account or require manual entries by a user or operator. To this end, the control unit may comprise an arithmetic and logic unit, for example a processor.

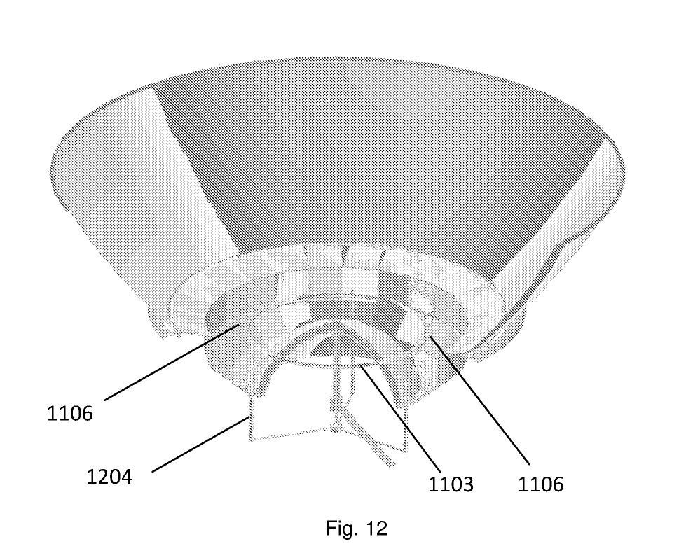

FIG. 12 shows a possible mechanism for extending the nozzles 1106. The nozzles are placed on a distributing ring 1103, which can be extended via three guides 1204, i.e., the distributing ring can be moved between an idle position of the cleaning system, in which solar collector operation is only sparingly disrupted, if at all, and a cleaning position or active position, in which cleaning takes place. In principle, all possible suitable mechanisms can be used for this purpose.

As a consequence, several embodiments and aspects of the present invention have been described. Even though the present invention was described based on specific exemplary embodiments, it shall be understood that the present invention must not be construed as being limited by these exemplary embodiments. In particular, it must also be noted that the two separately described aspects can of course be combined. For example, a cleaning system described in conjunction with a first aspect can of course also be realized in a solar collector or solar collector system according to the second aspect. Conversely, a solar collector system according to the first aspect can of course comprise a retaining system or tracking system according to any of the exemplary embodiments of the second aspect. In addition, let it be noted that “comprising” does not preclude any other elements or steps, and that “a” or “an” do not rule out a plurality. Let it further be pointed out that features or steps that have been described with reference to one of the above exemplary embodiments or configurations can also be used in combination with other features or other exemplary embodiments described above. Reference numbers in the claims are not to be construed as a limitation.

1. A solar collector system, which comprises at least one collector and one cleaning system with cleaning nozzles, which is attached to the collector, wherein the cleaning nozzles are configured in such a way that, by using them, a cleaning medium or fluid is guidable to the collector.

2. The solar collector system according to claim 1, wherein the cleaning nozzles are movably mounted.

3. The solar collector system according to claim 1, which further comprises a distributing ring on which the cleaning nozzles are arranged, and which is extendable by way of guides.

4. The solar collector system according to claim 1, wherein the solar collector system is configured in such a way that the collectors assume a closed protective position during the cleaning process, in which an interior space between the collectors is sealed.

5. The solar collector system according to claim 4, wherein the solar collector system comprises a plurality of solar collectors, and is configured in such a way that the protective position is assumable by closing the solar collectors in pairs at the mirror ends of the solar collectors.

6. The solar collector system according to claim 5, which comprises rubber sealings secured to the minor ends.

7. The solar collector system according to claim 5, which comprises a retaining device configured in such a way that the solar collectors are stably positioned in the protective position and pressed against each other by the retaining device.
